(19) United States
(12) Patent Application Publication
(10) Pub. No.: US 2023/0416130 A1
(43) Pub. Date: Dec. 28, 2023

(54) METHOD AND DEVICE FOR WATER MINERALIZATION

(71) Applicant: Alexander SILBERMAN, Haifa (IL)

(72) Inventor: Alexander SILBERMAN, Haifa (IL)

(21) Appl. No.: 18/031,845

(22) PCT Filed: Oct. 12, 2021
(86) PCT No.: PCT/IL2021/051217

§ 371 Date: Apr. 13, 2023

Related U.S. Application Data
(60) Provisional application No. 63/090,751, filed on Oct. 13, 2020.

(51) Int. Cl. C02F 9/00; C12C 5/00

(52) U.S. Cl. CPC C02F 9/00; C12C 5/002; C02F 1/688

(57) ABSTRACT

A method for water mineralization is disclosed. At least one mineral that is only sparingly soluble at a pH of 7 but that is highly soluble at pH<3 is introduced into the anolyte zone of an electrolyzer, where the applied voltage creates a low-pH environment. The at least one mineral rapidly dissolves in the acidic anolyte, thereby mineralizing the anolyte. A device for performing the method is also disclosed.

### REFERENCE TO RELATED PUBLICATIONS

This application claims priority from U.S. Provisional Patent Application No. 63/090,751, filed 13 Oct. 2020.

### FIELD OF THE INVENTION

This invention relates in general to methods and devices for improving the quality of water. It relates specifically for methods and devices for increasing the concentrations of minerals, ions, oxygen, and/or hydrogen in water.

### BACKGROUND OF THE INVENTION

At present, only natural water, mineral water, and purified water can be used as drinking water. Tap water is generally safe and contains beneficial mineral substances. Due to infrastructure aging, residual chlorine, secondary pollution, etc., tap water is not always considered the most preferable source of drinking water. High-level purification can increase the palatability and safety of tap water. Mineral water generally has a higher mineral content than tap water, but may not be suitable for long-term consumption. Some mineral waters have been found to have unacceptable levels of harmful components such as heavy metals, and some mineral waters have been found to have a high redox potential. Purified water produced by reverse osmosis is very different from traditional drinking water. It has very low concentrations of trace elements, is clean, and contains no bacteria or viruses. Since bodily fluids are slightly alkaline, however, long-term consumption of slightly acidic purified water can be harmful to the internal environment of the body, so weakly basic purified water is preferable as a drinking water.

Currently, two types of devices are known for mineralizing water purified by reverse osmosis (henceforth “RO”): dosage systems that add desired quantities of salts and filters that add salts as the RO-purified water passes through them. The primary disadvantage of dosage systems arises from the low solubility of calcium salts, thus making preparation of concentrated solutions impossible and thereby causing the necessity of frequent replacement of the cartridges containing the salts, and making maintenance of dosage systems expensive. Similarly, the low solubility of calcium salts makes it difficult for filter systems to supply the desired level of mineralization.

Many systems and methods for mineralization of water have been disclosed in the prior art. Representative examples of disclosures dosage methods include Russian Pat. No. 2417953, which discloses a method for water mineralization by dosing from aqueous solutions of salts containing the elements of interest; Chinese Pat. No. 98100621, which discloses a method for preparing mineral water by adding at least three kinds of mineral salts to purified water; and Chinese Pat. No. 99105060, which discloses a method for preparing mineralized water by adding trace elements and carbon dioxide to purified water. Representative examples of disclosures of filtration methods include U.S. Pat. Appl. Pub. No. 2013/0115335, which discloses a method for preparing filter material for use in filtration mineralization systems, and Chinese Pat. No. 95108667, which discloses a method for preparing high oxygen content drinking water by a combination of filtration and addition of oxygen.

In light of the difficulties and problems with known mineralization methods and systems known in the art, it is clear that an improved method and system for mineralization of water remains a long-felt but as yet unmet need.

### SUMMARY OF THE INVENTION

The invention disclosed herein is designed to meet this need. The invention is based on the dramatic increase in the solubility of many minerals such as dolomite (calcium magnesium carbonate, CaMg(CO₃)₂), magnesite (magnesium carbonate, MgCO₃), hematite (iron(III) oxide), etc., and inorganic compounds and salts such as many metal oxides, carbonates, sulfates, etc., upon lowering of the pH; an acidic medium is created in the anolyte zone of an electrolyzer, thereby enabling introduction of significant amounts of magnesium, calcium, or both, into the water to be treated.

It is therefore an object of the present invention to disclose a method for mineralizing water, comprising: flowing inlet water (400) through an electrolyzer, thereby creating an anolyte and a catholyte; applying voltage to said water, thereby lowering the pH of said anolyte; introducing into said anolyte at least one mineral or inorganic compound that is more soluble at pH<3 than at neutral pH, thereby at least partially dissolving said at least one mineral or inorganic compound; and, passing said anolyte to said water, thereby mineralizing said water.

It is a further object of this invention to disclose the method as defined in any of the above, wherein said at least one mineral or inorganic compound is selected from the group consisting of substances that are insoluble in water at neutral pH; substances that are very slightly soluble in water at neutral pH; substances that are slightly soluble in water at neutral pH; and substances that are sparingly soluble at neutral pH. In some embodiments of the invention, said at least one mineral or inorganic compound is selected from minerals or inorganic compounds that comprise oxides, hydroxides, carbonates, and sulfates.

It is a further object of this invention to disclose the method as defined in any of the above, wherein said at least one mineral or inorganic compound comprises at least one cation selected from the group consisting of Ca²⁺, Mg²⁺, Feⁿ⁺(n=2 or 3), Mn^{m+}(2≤m≤7), and Zn²⁺.

In some preferred embodiments of the method, at least one of the following is true:
said at least one cation comprises at least one cation selected from the group consisting of Ca²⁺ and Mg²⁺ and said at least one mineral or inorganic compound is at least one mineral selected from the group consisting of dolomite and magnesite;
said at least one cation is Fe²⁺ and said at least one mineral or inorganic compound is at least one mineral selected from the group consisting of magnetite and siderite;
said at least one cation is Fe³⁺ and said at least one mineral or inorganic compound is at least one mineral selected from the group consisting of hematite and limonite;
said at least one cation is Mn⁴⁺ and said at least one mineral or inorganic compound is at least one mineral selected from the group consisting of pyrolusite and manganite; and,
said at least one cation is Zn²⁺, and said at least one mineral or inorganic compound is at least one mineral or inorganic compound selected from the group consisting of zinc oxide, zinc carbonate, zincite, and smithsonite.

In some preferred embodiments of the method, said at least one mineral or inorganic compound comprises at least one cation selected from the group consisting of Ca²⁺ and Mg²⁺, and said at least one mineral or inorganic compound is at least one mineral selected from the group consisting of dolomite and magnesite. In some embodiments of the method in which said cation is selected from the group consisting of Ca²⁺ and Mg²⁺, said step of introducing into said anolyte at least one mineral comprises introducing a mixture of minerals in order to provide a predetermined calcium/magnesium ratio to said water. In some preferred embodiments of the method in which said cation is selected from the group consisting of Ca²⁺ and Mg²⁺ and said step of introducing into said anolyte comprises introducing into said anolyte a mixture of minerals, said mixture of minerals comprises a mixture of minerals selected from the group consisting of dolomite, limestone, marble, magnesite, and aragonite.

It is a further object of this invention to disclose the method as defined in any of the above, wherein said electrolyzer is a diaphragm electrolyzer. In preferred embodiments of the method, said diaphragm electrolyzer is characterized by an anolyte: catholyte volume ratio of between 3:7 and 7:3.

It is a further object of this invention to disclose the method as defined in any of the above, wherein said step of flowing inlet water through an electrolyzer is preceded by a step of adding a salt to said inlet water, thereby increasing the conductivity of said inlet water. In some preferred embodiments of the method, said salt comprises sodium sulfate. In some preferred embodiments of the method, said step of adding salt to said inlet water comprises passing said inlet water through a salt dispensing cartridge (300) adapted to provide said salt to said inlet water, thereby dissolving said salt in said inlet water. In some preferred embodiments of the method, said salt dispensing cartridge is adapted to provide slow release of said salt. In some especially preferred embodiments of the invention, said salt dispensing cartridge comprises gypsum and at least one second substance selected from the group consisting of zeolites and ion exchange resins, said second substance charged with sodium ions and disposed such that in an aqueous environment, said gypsum will react with said second substance to produce sodium sulfate.

It is a further object of this invention to disclose the method as defined in any of the above, comprising flowing catholyte through said salt dispensing cartridge (300). In some preferred embodiments of the method, said catholyte flows through said cartridge (300) at a rate sufficient to maintain the water therein at a pH of between 7 and 8.5.

It is a further object of this invention to disclose the method as defined in any of the above, wherein said step of flowing inlet water through an electrolyzer comprises dividing said flow into two flows, one of which passes through said electrolyzer and one of which bypasses said electrolyzer. In some preferred embodiments of the method, said flow through said electrolyzer and said flow bypassing said electrolyzer are characterized by a flow ratio of between 1:20 and 1:1.

It is a further object of this invention to disclose the method as defined in any of the above, wherein said step of applying voltage comprises applying a voltage of between 1 and 24 volts.

It is a further object of this invention to disclose the method as defined in any of the above, wherein said step of applying voltage comprises applying a voltage sufficient to lower said pH of said anolyte to a predetermined value.

It is a further object of this invention to disclose the method as defined in any of the above, wherein said step of introducing at least one mineral comprises passing said inlet water through a mineral dispensing cartridge (310) containing said at least one mineral, said cartridge located within an anode chamber of said electrolyzer.

It is a further object of this invention to disclose the method as defined in any of the above, wherein said step of introducing at least one mineral comprises passing said inlet water through a mineral dispensing cartridge (310) containing said at least one mineral, said cartridge located external to and downstream of electrolyzer.

It is a further object of this invention to disclose the method as defined in any of the above, comprising introducing at least one additional trace element into said water.

It is a further object of this invention to disclose the method as defined in any of the above, wherein said at least one mineral is in the form of granules. In some preferred embodiments of the method, said granules are characterized by a diameter of between 0.1 mm and 5 cm. In some preferred embodiments of the method, said granules comprise a water-soluble binder. In some especially preferred embodiments of the method, said binder is selected from the group consisting of molasses, lignosulfonates, and mixtures thereof.

It is a further object of this invention to disclose the method as defined in any of the above, comprising monitoring anolyte conductivity in order to determine a status of said mineral dispensing cartridge (310).

It is a further object of this invention to disclose the method as defined in any of the above, comprising generating oxygen at an anode of said electrolyzer, thereby enriching said water in oxygen.

It is a further object of this invention to disclose the method as defined in any of the above, comprising generating hydrogen at a cathode of said electrolyzer, thereby enriching said water in hydrogen.

It is a further object of this invention to disclose the method as defined in any of the above, comprising controlling at least one variable selected from the group consisting of flow rate and applied voltage in order to introduce a predetermined quantity of said mineral into said water.

It is a further object of this invention to disclose the method as defined in any of the above, wherein said method is adapted for producing mineralized water suitable for use in preparation of beer, and further wherein:
said step of introducing into said anolyte at least one mineral or inorganic compound that is more soluble at pH<3 than at neutral pH comprises introducing into said anolyte at least one mineral or inorganic compound comprising at least one cation selected from the group consisting of Ca²⁺, Mg²⁺, Fe²⁺, Zn²⁺, and Mn^{m+} (2<m<4); and,
said step of introducing into said anolyte at least one mineral or inorganic compound that is more soluble at pH<3 than at neutral pH, thereby at least partially dissolving said mineral comprises: (a) dissolving sufficient Ca²⁺to provide a Ca²⁺ concentration of between 50 and 200 mg/L; (b) dissolving sufficient Mg²⁺to provide a Mg²⁺ concentration of between 50 and 200 mg/L; (c) dissolving sufficient Fe²⁺ to provide a Fe²⁺ concentration of >0.2 mg/L; (d) dissolving sufficient Zn²⁺to provide a Zn²⁺ concentration of between 0.1 and 0.25 mg/L; and, (e) dissolving sufficient Mn^{m+} to provide a Mn^{m+} concentration of between 0.16 and 0.56 μm/L.

It is a further object of this invention to disclose the method as defined in any of the above, wherein said method is adapted for producing mineralized water suitable for producing water for fermentation in the production of distilled alcoholic beverages, and further wherein:
said step of introducing into said anolyte at least one mineral or inorganic compound that is more soluble at pH<3 than at neutral pH comprises introducing into said anolyte at least one mineral or inorganic compound comprising Ca²⁺, Mg²⁺, and Fe²⁺; and,
said step of introducing into said anolyte at least one mineral or inorganic compound that is more soluble at pH<3 than at neutral pH, thereby at least partially dissolving said mineral comprises: (a) dissolving sufficient Ca²⁺ to provide a Ca²⁺ concentration of between 0 and 100 mg/L; (b) dissolving sufficient Mg²⁺to provide a Mg²⁺ concentration of between 0 and 100 mg/L; and, (c) dissolving sufficient Fe²⁺ to provide a Fe²⁺ concentration of between 0 and 0.1 mg/L.

It is a further object of this invention to disclose the method as defined in any of the above, wherein said method is adapted for producing potable mineral water, and further wherein said step of introducing into said anolyte at least one mineral or inorganic compound that is more soluble at pH<3 than at neutral pH comprises introducing at least one mineral or inorganic compound that comprises a predetermined set of cations in concentrations suitable for potable mineral water.

It is a further object of this invention to disclose a device for mineralizing water, comprising: an electrolyzer, said electrolyzer comprising an anode (100) and a cathode (110); a source of at least one mineral that is more soluble at pH<3 than at pH=7; and, flow means for flowing inlet water (400) through said electrolyzer so as to dissolve at least partially said at least one mineral in anolyte of said electrolyzer and thereby provide mineralized water.

It is a further object of this invention to disclose such a device, wherein said electrolyzer is a diaphragm electrolyzer. In some preferred embodiments of the invention, said electrolyzer is characterized by an anolyte: catholyte volume ratio of between 7:3 and 3:7.

It is a further object of this invention to disclose the device as defined in any of the above, wherein said source of at least one mineral comprises a mineral dispensing cartridge (310) disposed within an anode chamber of said electrolyzer.

It is a further object of this invention to disclose the device as defined in any of the above, wherein said source of at least one mineral comprises a mineral dispensing cartridge (310) disposed outside of and downstream of said electrolyzer.

It is a further object of this invention to disclose the device as defined in any of the above, wherein said flow means are adapted to provide a flow, part of which flows through said electrolyzer and part of which bypasses said electrolyzer. In some preferred embodiments of the invention, said flow means are adapted to provide a flow, part of which flows through said electrolyzer and part of which bypasses said electrolyzer, said flow through said electrolyzer and said flow bypassing said electrolyzer characterized by a ratio of between 1:20 and 1:1.

It is a further object of this invention to disclose the device as defined in any of the above, additionally comprising a source of a conductivity-enhancing salt, said source disposed upstream of said electrolyzer, and introducing means for introducing said salt into said inlet water. In some preferred embodiments of the device, said source of a conductivity-enhancing salt comprises a salt dispensing cartridge (300) containing said salt. In some more preferred embodiments of the invention, said salt dispensing cartridge is adapted to provide slow release of said salt. In some especially preferred embodiments of the invention, said salt dispensing cartridge comprises gypsum and at least one second substance selected from the group consisting of zeolites and ion exchange resins, said second substance charged with sodium ions and disposed such that in an aqueous environment, said gypsum will react with said second substance to produce sodium sulfate.

It is a further object of this invention to disclose the device as defined in any of the above, comprising: a fluid connection between a catholyte volume of said electrolyzer and said salt dispensing cartridge (300); and, flow means for flowing catholyte from said catholyte volume to said salt dispensing cartridge (300) at a predetermined flow rate.

It is a further object of this invention to disclose the device as defined in any of the above, wherein said anode is constructed of a material selected from the group consisting of rutile; graphite; nickel; stainless steel coated by at least one material selected from the group consisting of nickel, tantalum, and noble metals; carbon paper; and woven carbon fiber cloth.

It is a further object of this invention to disclose the device as defined in any of the above, wherein said source of at least one mineral constructed of perforated stainless steel coated by a noble metal.

It is a further object of this invention to disclose the device as defined in any of the above, wherein said source of at least one mineral comprises a shell made from at least one material selected from the group consisting of carbon paper and woven carbon fiber cloth, supported by a frame made of at least one substance selected from the group consisting of stainless steel coated by a noble metal and graphite.

It is a further object of this invention to disclose the device as defined in any of the above, wherein said cathode is constructed of zinc-coated stainless steel.

It is a further object of this invention to disclose the device as defined in any of the above, comprising a microprocessor programmed to calculate an amount of mineral introduced into said water at a given flow rate and applied voltage.

It is a further object of this invention to disclose the device as defined in any of the above, comprising a microprocessor programmed to calculate an amount of mineral introduced into said water at a given flow rate and applied voltage and control means for controlling at least one variable selected from the group consisting of flow rate and applied voltage in order to introduce a predetermined quantity of said mineral into said water.

It is a further object of this invention to disclose the device as defined in any of the above, additionally comprising a user interface comprising selection means that enable a user to select a level of mineralization. In some preferred embodiments of the device, said user interface comprises selection means that enable a user to select an option selected from the group consisting of oxygen enrichment of said water and hydrogen enrichment of said water.

### BRIEF DESCRIPTION OF THE DRAWINGS

The invention will now be described with reference to the drawings, wherein:

FIG. 1 is a schematic diagram of one non-limiting embodiment of the device disclosed herein, in which the device comprises an external mineralization cartridge;

FIG. 2 is a schematic diagram of a second non-limiting embodiment of the device disclosed herein, in which the device comprises a built-in mineralization cartridge; and,

FIG. 3 is a schematic diagram of a third non-limiting embodiment of the device disclosed herein, in which catholyte is used to adjust the pH of the water being treated.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest reasonable interpretation of said claims. In some cases, for clarity or conciseness, individual elements of the invention are discussed separately. Nonetheless, any combination of elements of the invention that is not self-contradictory is considered by the inventor to be within the scope of the invention.

As used herein, the following terms are used to describe the solubility of a given solute in a given solvent. The term “sparingly soluble” refers to solute of which between 1 and 3.3 g dissolves in 100 ml of solvent; the term “slightly soluble” refers to a solute of which between 0.1 and 1 g dissolves in 100 ml of solvent; the term “very slightly soluble” refers to a solute of which between 0.01 and 0.1 g dissolves in 100 ml of solvent; and the term “insoluble” refers to a solute of which less than 0.01 g dissolves in 100 ml of solvent.

As used herein, the abbreviation “RO” stands for “reverse osmosis.”

As used herein, the term “noble metal” refers to elements in groups 8-11 of the periodic table and in periods 5 and greater.

In the invention disclosed herein, an acidic environment is created within the anolyte zone of an electrolyzer. It is well-known in the art that increasing the applied voltage in the electrolyzer will decrease the pH of the anolyte, and thereby increase the solubility of the mineral of interest. The specific pH dependence of the solubilities of sparingly soluble salts such as carbonates can readily be calculated from the known solubility properties of the salts and the acid dissociation constants of the conjugate acid of the anion. Thus, by controlling the electrolyzer voltage, the solubility of the salts of interest within the acid environment in the anolyte zone can be controlled as well. It is thus possible to model the amount of mineral that will be introduced into the anolyte as a function of the applied voltage.

The following discussion regarding operating conditions of the invention disclosed herein is provided to enable a person of ordinary skill in the art to make and use the invention, in particular, to understand how the optimal operating conditions for the electrolyzer are determined.

The total voltage on the electrolyzer U is defined by eq (1):

U=Eₐ+ψₐ+IR+ΔUₘ+E_{c}+ψ_{c} (1)

where Eₐ and E, are the anode and cathode potential in the electrolyte, respectively; ψₐ and ψ_{c} are the overpotentials for hydrogen and oxygen evolution, respectively; IR is the ohmic potential drop in the electrolyzer; and ΔUₘ is the voltage drop across the membrane in the electrolyzer.

In order to optimize the performance of the electrolyzer as it is used in the instant invention, the energy loss on gas evolution should be minimized. Ideally, ψₐ and ψ_{c} should be zero. In this case, the total voltage on the electrolyzer reduces to the formula given by eq (2):

U=Eₐ+IR+ΔUₘ+E_{c} (2)

This requirement is the opposite of the conditions under which electrolyzers are typically run; in general, in systems known in the art, high gas evolution is a desired parameter for electrolyzer operation, in contrast to the instant invention, in which gas evolution is an undesired side product. In preferred embodiments of the invention, the voltage on the voltage U is less than 24 volts.

Thus, in order to optimize electrolyzer performance in the instant invention, electrode material should be chosen to maximize the overpotential of hydrogen and oxygen evolution at the anode and cathode, respectively.

A second condition for optimization of electrolyzer performance is minimization of heat losses (R), eq (3):

$$R = ρ \frac{d}{S} \qquad ( 3 )$$

where p is the electrical resistance of water, d is the distance between the electrodes, and S is the electrode area.

In order to minimize heat losses, a salt cartridge is provided in order to provide low resistance. Ideally, the electrode area would be enlarged as much as possible, and the distance between the electrodes minimized. Increasing the size of the electrodes will increase production costs, while decreasing the distance between the electrodes will lower the efficiency of the apparatus, however. Thus, in practice, the construction of the electrolyzer will represent a compromise between the losses inherent in a non-ideal configuration and the gains obtained from the lower construction and operating costs of the best practical configuration.

An analogous compromise may need to be made in the choice of membrane material between materials that provide an optimum value of ΔUₘ and materials that are sufficiently robust to provide a longer useful life before replacement is necessary.

A person of ordinary skill in the art will readily understand from the preceding description of the electrolyzer that for any particular application of the invention, the specific details of the design of the electrolyzer will necessarily take into account the productivity and efficiency of the electrolyzer (e.g. flow rate, electrode separation); the production costs; and the purity of the water used (which will affect the choice of electrode and membrane material).

Thus, at a given flow rate, the device can supply any desired amount of trace mineral to water to be treated; the final mineral concentration will of course depend on the flow rate through the electrolyzer. In preferred embodiments of the invention, the device is controlled by a microprocessor programmed to calculate the trace element concentration as a function of applied voltage and flow rate, and to adjust the voltage as required to obtain the desired level of mineralization.

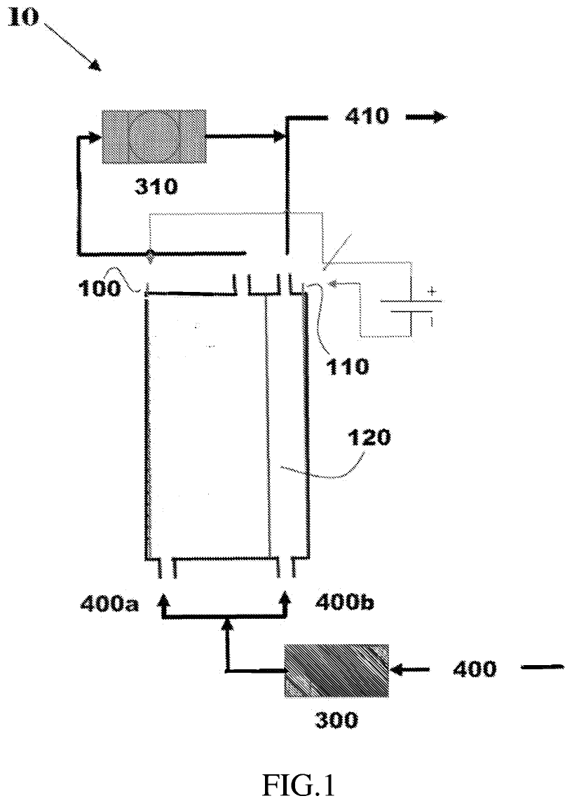

Reference is now made to FIG. 1, which presents a schematic diagram of one non-limiting embodiment of the device disclosed herein. The electrolyzer comprises anode 100, cathode 110, and membrane 120 separating the two electrodes. In preferred embodiments of the invention, the electrolyzer voltage is between 1 and 24 volts; as explained above, the exact voltage will depend on the desired pH and level of mineralization. The inlet water 400 is divided into two parts, one of which (400a) passes through the anolyte zone and one of which (400b) passes through the catholyte zone. In this embodiment of the invention, the mineral or minerals to be introduced into the water are contained in mineral dispensing cartridge 310 located downstream of and external to the electrolyzer. The water then passes from the anode zone through the mineral dispensing cartridge, dissolving minerals, and then is mixed with the stream from the catholyte to form exit stream 410, which is then delivered to the water to be treated. In the embodiment of the invention shown in FIG. 1, all of the water flows through the electrolyzer. In some embodiments of the invention (not shown in the figure), the water stream to be treated is divided into two streams, one of which passes through the electrolyzer and the other of which bypasses it. In preferred embodiments of the invention in which part of the water stream bypasses the electrolyzer, the ratio of the flow of water that passes through the electrolyzer to the flow of water that bypasses it is between 1:20 and 1:1.

In cases in which the water to be treated is insufficiently conductive, e.g. in the case in which the water to be mineralized has been purified by RO, a salt must be added to the water to be treated in order to raise its conductivity. The salt is preferably not one such as a chloride that can cause gas evolution at the electrodes. In some embodiments of the invention, the salt is selected from the group consisting of sulfates, phosphates, and citrates. In preferred embodiments of the invention, sodium sulfate is used. The salt can be added by any means known in the art. Typical non-limiting embodiments include adding salt directly to the water by dosing the pump used to create the flow of water and using a salt dispensing cartridge 300 charged with the salt or with substances that will react to form the salt. In some preferred embodiments of the invention, the salt dispensing cartridge is a slow-release salt dispensing cartridge that is designed to limit the rate at which the highly soluble conductivity-enhancing salt is delivered to the inlet water. In one typical non-limiting embodiment of a slow-release salt dispensing cartridge, the cartridge comprises gypsum (CaSO₄) and a zeolite or ion-exchange column charged with sodium ions. In an aqueous environment, the gypsum and the sodium ions will react to form sodium sulfate, but the low solubility of gypsum in water limits the rate at which the reaction proceeds, thereby limiting the rate of formation of the sodium sulfate and therefore the rate at which the salt enters the water, thereby extending the lifetime of the cartridge. In the embodiment of the invention shown in FIG. 1, the flow of RO-purified water 400 passes through salt dispensing cartridge 300 containing the conductivity-enhancing salt prior to flowing through the electrolyzer.

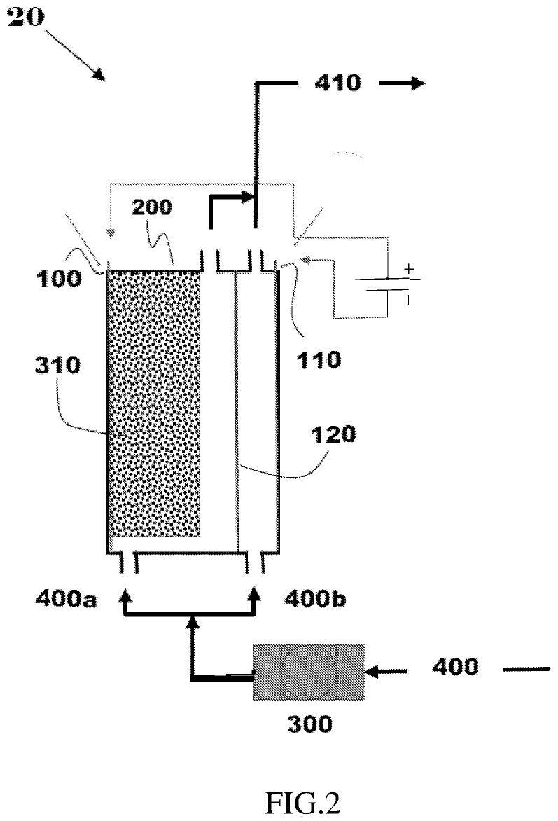

Reference is now made to FIG. 2, which is a schematic diagram of a second non-limiting embodiment of the invention. In this embodiment, mineral dispensing cartridge 310 is incorporated into anode cartridge 200 within the electrolyzer.

In preferred embodiments of the invention, a diaphragm electrolyzer is used because the design of the diaphragm electrolyzer inherently prevents mixing of anolyte and catholyte. In especially preferred embodiments of the invention in which a diaphragm electrolyzer is used, the anolyte: catholyte volume ratio is between 7:3 and 3:7.

In some preferred embodiments of the invention, the cathode is made from zinc-coated stainless steel. Typical non-limiting examples of materials from which the anode is constructed in some preferred embodiments of the invention include rutile, graphite, carbon paper, woven carbon fiber cloth, nickel, stainless steel coated with nickel, tantalum, and noble metals such as ruthenium, osmium, rhodium, iridium, platinum, palladium, and gold. In the most preferred embodiments of the invention, the choice of anode material is made so that the system will meet the requirement that stainless steel alloying additives such as chromium and molybdenum will not enter the water being treated.

The cartridge body may be made of any material known in the art that complies with regulations regarding treatment of water for the intended use of the water being treated (e.g. drinking water, water for use in agriculture, etc.). In some preferred embodiments of the invention, the cartridge body is constructed of perforated stainless steel coated by a noble metal. In some other preferred embodiments of the invention, the cartridge body comprises a shell made from at least one material selected from the group consisting of carbon paper and woven carbon fiber cloth, supported by a frame made of at least one substance selected from the group consisting of stainless steel coated by a noble metal and graphite.

Because many minerals that contain metal cations of interest (e.g. Mg²⁺, Ca²⁺, etc.) are readily soluble at pH<3, and dissolve rapidly under these conditions, the device and method disclosed herein provide a simple and elegant method for producing mineralized water that is enriched in these minerals, which are essential for human nutrition but are removed from water by the desalination methods typically used in water treatment.

In preferred embodiments of the invention, the minerals that are the source of the trace elements that mineralize the water are granulated; the granules can be produced by either wet or dry granulation. In preferred embodiments of the invention, the granules are characterized by an average diameter of between 0.1 mm and 5 cm. In preferred embodiments of the invention, in order to increase the mechanical strength of the granules, a binder is used in the granulation process. Any water-soluble binder known in the art that complies with relevant regulations regarding the content of the water may be used. In preferred embodiments of the invention, the binder comprises molasses, lignosulfonate, or a mixture thereof. In preferred embodiments of the invention, the binder concentration in the granules is between 0.5% and 10% by weight.

In cases in which trace elements other than or in addition to calcium and magnesium are desired, salts or minerals containing the desired trace element are added to the granules. In a preferred embodiment of the invention in which the water is mineralized by addition of calcium and magnesium, a mixture of calcium- and magnesium-containing minerals is used as the source of the elements and the desired calcium/magnesium ratio obtained by appropriate choice of the relative amounts of the minerals. Non-limiting examples of minerals that can be mixed in this fashion include dolomite, limestone, marble, magnesite, and aragonite. In some preferred embodiments of the invention in which the calcium/magnesium ratio is controlled by mixing different minerals, the mixture comprises primarily dolomite, with smaller amounts of one or more other minerals added to correct the calcium/magnesium ratio.

Similarly, in embodiments of the invention in which the water is mineralized by addition of iron, iron-containing minerals such as hematite and/or limonte for addition of Fe³⁺ and/or magnetite or siderite for addition of Fe²⁺ may be used. In embodiments in which the water is mineralized by addition of manganese, manganese-containing minerals such as pyrolusite and/or manganite can be used. Because manganese in its highest oxidation states (e.g. Mn⁷⁺ as in permanganate) is not suitable for drinking water or water to be used in irrigation, in preferred embodiments of the invention, the manganese containing minerals or compounds that are used comprise manganese in an oxidation state of 2-4 inclusive. In embodiments of the invention in which the water is mineralized by addition of zinc, zinc oxide and/or zinc carbonate may be used, either in the form of the salt or by addition of zincite and/or smithsonite.

The amount of anolyte into which the minerals are introduced is much smaller than the total volume of water being treated. Thus, introduction of the anolyte into the much larger volume of water being treated will not significantly affect the pH of the water being treated, and the amount of mineral added to the anolyte can be controlled as described above while taking into account the relative volumes of anolyte and water to be treated such that the amount of minerals added into the treated water (pH ˜7) will remain at a concentration sufficiently low that no precipitation will occur.

In some preferred embodiments of the invention, the conductivity of the water in the electrolyzer is used to determine the status of the cartridge containing the mineral to be solubilized. A decrease in the calcium/magnesium sulfate content will lead to a local decrease in the pH, thereby increasing the conductivity of the anolyte. Thus, an increase in conductivity indicates that the cartridge needs to be recharged or replaced.

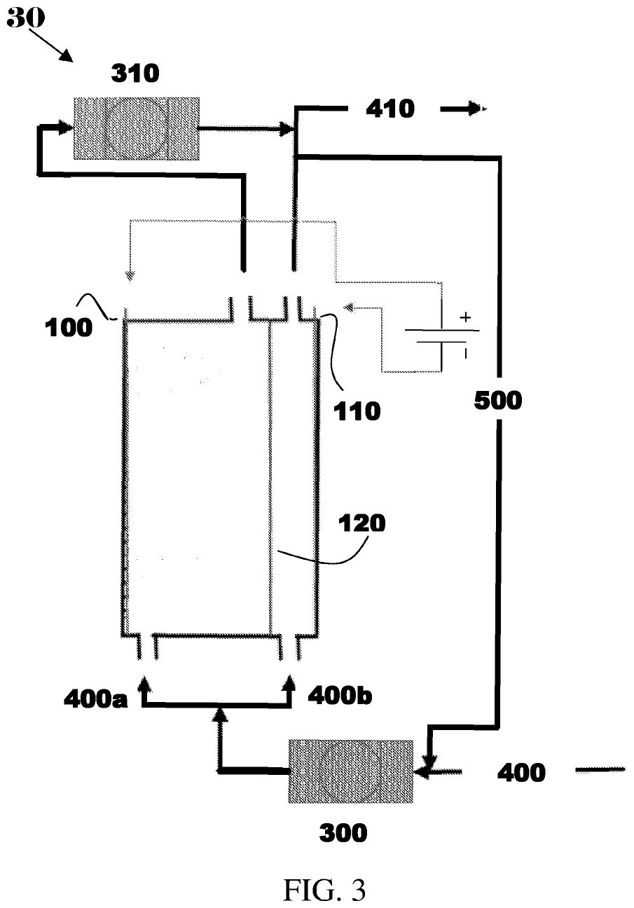

In some non-limiting embodiments of the invention, the device and method are used to control the pH of the water being treated. Reference is now made to FIG. 3, which illustrates schematically one of these embodiments. A basic catholyte 500 flows through the cartridge. The OH⁻ ions in the catholyte will react with Ca²⁺ions to form Ca(OH)₂, which is insoluble, thereby decreasing the pH of the water. In preferred embodiments of the invention, the catholyte flows through cartridge 300 (the cartridge containing the conductivity-enhancing salt) in order to maintain the water flowing through the cartridge at a pH of between 7 and 8.5.

In some embodiments of the invention, the device and method are used to produce water that is enriched with O₂ or H₂. Oxygen-enriched water is produced by decreasing oxygen evolution at the anode of the electrolyzer. In preferred embodiments, this decrease is accomplished by selection of an anode material characterized by a low oxygen evolution overvoltage or by decreasing the anode: cathode area ratio or both. Hydrogen-enriched water is produced by decreasing hydrogen evolution at the cathode of the electrolyzer. In preferred embodiments, this increase is accomplished by selection of an anode material with a low oxygen evolution overvoltage or by increasing the anode: cathode area ratio or both.

In some embodiments of the invention, the device comprises a delivery system. As mentioned above, the degree of mineralization in general can be controlled by a microprocessor programmed to adjust the applied voltage in order to provide a desire level of mineralization at a given flow rate. In preferred embodiments of the delivery system, the device comprises a user interface that allows the user to select a mineralization level from “no mineralization” for applications such as filling a kettle in which the water is preferably not mineralized to “high mineralization.”

As mentioned above, the system and method disclosed herein can produce oxygen-enriched water by applying a voltage higher than the oxygen evolution overvoltage on the anode, or hydrogen-enriched water by applying a voltage higher than the hydrogen evolution overvoltage on the cathode. Thus, in some embodiments of the invention, one or both of these possibilities is included as an option, and the user interface of the delivery device includes an option, separate from the option for choosing a mineralization level, for choosing to produce water enriched in either hydrogen or oxygen, or not enriched in either.

The device and method disclosed herein can be used to produce water for any appropriate purpose. As discussed above, water produced by purification methods known in the art tends to be low in magnesium, a vital nutrient. The inventive method provides a cost-effective and efficient method for providing water containing magnesium. Thus, the water produced by the method described herein could be used as drinking water, thereby obviating the need for dietary magnesium supplements, or as water for irrigation, thereby limiting or eliminating the necessity for the use of magnesium-containing fertilizers. By addition of other minerals in appropriate concentrations, potable mineral water can be produced.

Another non-limiting example of an application of the invention disclosed herein is its use in the production of mineralized water for production of fermented alcoholic beverages such as beer or distilled alcoholic beverages such as whisky or vodka.

Historically, different regions have become famous for their classic beer styles as defined by the waters available for brewing. For example, the famous brewing waters from the deep wells at Burton-on-Trent are known for their excellent qualities in brewing full-flavored pale ales. Burton water is high in permanent hardness because of the high calcium and sulfate content, but it also has a lot of temporary hardness from a high level of bicarbonate. Munich water is poor in sulfates and chloride but contains carbonates, which are not very desirable for pale beers but ideal for producing darker, mellower lagers. The invention disclosed herein can be used to produce water with mineral content similar to that used in the preparation of beer. In preferred embodiments, the water is mineralized as disclosed above to produce mineralized water comprising 50-200 mg/L (each) Ca²⁺ and Mg²⁺, 75-150 mg/L Na⁺, about 10 mg/L K+, >0.2 mg/L Fe³⁺, and 0.1-0.25 mg/L Zn²⁺. In some embodiments, about 0.1 mg/L Cu²⁺ is added as well; note that Cu²⁺ is toxic in concentrations of greater than 10 mg/L.

Similarly, it is well-known in the art that in order to produce high-quality distilled alcoholic beverages such as whisky and vodka, it is essential to begin with high-quality water. In the case of production of whisky and vodka, water is used for two different purposes, for fermentation of the plant material and for dilution. The taste of the final product is determined primarily by the fermentation process. In some embodiments of the instant invention, mineralized water is used for the fermentation process. In preferred embodiments, the mineralized water has a Ca²⁺ and Mg²⁺ content of about 100 mg/L and trace amounts of Fe³⁺ (typically <0.1 mg/L). The invention disclosed herein can in principle be used to produce mineralized water for dilution of alcoholic beverages. In these embodiments, trace amounts of minerals are added, typically less than 1 mg/L of Ca²⁺ and Mg²⁺ and less than 10 ppm of other minerals.

As another non-limiting example, oxygen-enriched water is used in treatment of wounds, and the instant invention provides a cost-effective, efficient, and convenient method for producing and such water.

These non-limiting examples are provided merely to illustrate some of the uses and advantages of the invention disclosed herein. It will be clear to a person of ordinary skill in the art that there are any number of other uses and applications of embodiments of the invention disclosed herein.

1-54. (canceled)

55. A method for mineralizing water, comprising:
flowing inlet water (400) through an electrolyzer, thereby creating an anolyte and a catholyte;
applying voltage to said water, thereby lowering the pH of said anolyte;
introducing into said anolyte at least one mineral or inorganic compound that is more soluble at pH<3 than at neutral pH, thereby at least partially dissolving said at least one mineral or inorganic compound; and,
passing said anolyte to said water, thereby mineralizing said water;
wherein said step of flowing inlet water through an electrolyzer is preceded by a step of adding a highly soluble salt to said inlet water, thereby increasing the conductivity of said inlet water.

56. The method according to claim 55, wherein at least one of the following is true:
said at least one mineral or inorganic compound that is more soluble at pH<3 than at neutral pH comprises at least one cation selected from the group consisting of Ca²⁺, Mg²⁺, Feⁿ⁺ (n=2 or 3), Mn^{m+} (2<m<7), and Zn²;
said at least one mineral or inorganic compound that is more soluble at pH<3 than at neutral pH comprises at least one cation selected from the group consisting of Ca²⁺ and Mg²⁺ and said at least one mineral or inorganic compound is at least one mineral selected from the group consisting of dolomite and magnesite;
said at least one mineral or inorganic compound that is more soluble at pH<3 than at neutral pH comprises Fe²⁺ and said at least one mineral or inorganic compound is at least one mineral selected from the group consisting of magnetite and siderite;
said at least one mineral or inorganic compound that is more soluble at pH<3 than at neutral pH comprises Fe³⁺ and said at least one mineral or inorganic compound is at least one mineral selected from the group consisting of hematite and limonite;
said at least one mineral or inorganic compound that is more soluble at pH<3 than at neutral pH comprises Mn⁴⁺ and said at least one mineral or inorganic compound is at least one mineral selected from the group consisting of pyrolusite and manganite;
said at least one mineral or inorganic compound that is more soluble at pH<3 than at neutral pH comprises Zn²⁺, and said at least one mineral or inorganic compound is at least one mineral or inorganic compound selected from the group consisting of zinc oxide, zinc carbonate, zincite, and smithsonite; and,
said at least one mineral or inorganic compound that is more soluble at pH<3 than at neutral pH comprises Ca²⁺ and Mg²⁺ and said step of introducing into said anolyte at least one mineral comprises introducing a mixture of minerals in quantities adapted to provide a predetermined calcium/magnesium ratio to said water.

57. The method according to claim 55, wherein said highly soluble salt cannot cause gas evolution at electrodes of said electrolyzer.

58. The method according to claim 55, wherein said step of adding a highly soluble salt to said inlet water comprises passing said inlet water through a salt dispensing cartridge (300) adapted to provide said highly soluble salt to said inlet water, thereby dissolving said highly soluble salt in said inlet water.

59. The method according to claim 58, wherein said salt dispensing cartridge comprises gypsum and at least one second substance selected from the group consisting of zeolites and ion exchange resins, said second substance charged with sodium ions and disposed such that in an aqueous environment, said gypsum will react with said second substance to produce sodium sulfate.

60. The method according to claim 58, further comprising flowing catholyte through said salt dispensing cartridge (300).

61. The method according to claim 55, wherein said step of flowing inlet water through an electrolyzer comprises dividing said flow into two flows, one of which passes through said electrolyzer and one of which bypasses said electrolyzer.

62. The method according to claim 55, wherein said step of introducing at least one mineral comprises passing said inlet water through a mineral dispensing cartridge (310) containing said at least one mineral, said cartridge located in a location selected from the group consisting of:
within an anode chamber of said electrolyzer; and,
external to and downstream of said electrolyzer.

63. The method according to claim 55, comprising introducing at least one additional trace element into said water.

64. The method according to claim 55, comprising monitoring anolyte conductivity in order to determine a status of a cartridge containing said at least one mineral.

65. The method according to claim 55, comprising at least one step selected from the group consisting of:
generating oxygen at an anode of said electrolyzer, thereby enriching said water in oxygen; and,
generating hydrogen at a cathode of said electrolyzer, thereby enriching said water in hydrogen.

66. The method according to claim 55, wherein said method is adapted for producing mineralized water suitable for use in preparation of a beverage and said mineralized water is selected from the group consisting of mineralized water suitable for production of beer and mineralized water suitable for producing water for fermentation in the production of distilled alcoholic beverages, and further wherein:
if said mineralized water is mineralized water suitable for production of beer:
said step of introducing into said anolyte at least one mineral or inorganic compound that is more soluble at pH<3 than at neutral pH comprises introducing into said anolyte at least one mineral or inorganic compounds comprising Ca²⁺, Mg²⁺, Fe²⁺, Zn²⁺, and Mn^{m}+(2<m<7); and,
said step of introducing into said anolyte at least one mineral or inorganic compound that is more soluble at pH<3 than at neutral pH, thereby at least partially dissolving said mineral comprises:
dissolving sufficient Ca²⁺ to provide a Ca²⁺ concentration of between 50 and 200 mg/L;
dissolving sufficient Mg²⁺to provide a Mg²⁺concentration of between 50 and 200 mg/L;
dissolving sufficient Fe²⁺ to provide a Fe²⁺ concentration of >0.2 mg/L;
dissolving sufficient Zn²⁺to provide a Zn²⁺concentration of between 0.1 and 0.25 mg/L; and,
dissolving sufficient Mn^{m+} to provide a Mn^{m+} concentration of between 0.16 and 0.56 μm/L;
if said mineralized water is for fermentation in the production of distilled alcoholic beverages:
said step of introducing into said anolyte at least one mineral or inorganic compound that is more soluble at pH<3 than at neutral pH comprises introducing into said anolyte at least one mineral or inorganic compound that comprising Ca²⁺, Mg²⁺, and Fe²⁺; and,
said step of introducing into said anolyte at least one mineral or inorganic compound that is more soluble at pH<3 than at neutral pH, thereby at least partially dissolving said mineral comprises:
dissolving sufficient Ca²⁺ to provide a Ca²⁺ concentration of between 0 and 100 mg/L;
dissolving sufficient Mg²⁺to provide a Mg²⁺concentration of between 0 and 100 mg/L; and,
dissolving sufficient Fe²⁺to provide a Fe²⁺concentration of between 0 and 0.1 mg/L.

67. A device for mineralizing water, comprising:
an electrolyzer, said electrolyzer comprising an anode (100) and a cathode (110);
a source of at least one mineral that is more soluble at pH<3 than at neutral pH; and,
flow means for flowing inlet water (400) through said electrolyzer so as to dissolve at least partially said at least one mineral in anolyte of said electrolyzer and thereby provide mineralized water;
wherein said device comprises a source of a highly soluble conductivity-enhancing salt, said source disposed upstream of said electrolyzer, and introducing means for introducing said highly soluble salt into said inlet water upstream of said electrolyzer.

68. The device according to claim 67, wherein said source of at least one mineral comprises a mineral dispensing cartridge (310) disposed in a location selected from the group consisting of:
an anode chamber of said electrolyzer; and,
outside of and downstream of said electrolyzer.

69. The device according to claim 67, wherein said flow means are adapted to provide a flow, part of which flows through said electrolyzer and part of which bypasses said electrolyzer.

70. The device according to claim 67, wherein said source of a highly soluble conductivity-enhancing salt comprises a salt dispensing cartridge (300) adapted to deliver said highly soluble salt to said inlet water.

71. The device according to claim 70, wherein said salt dispensing cartridge comprises gypsum and at least one second substance selected from the group consisting of zeolites and ion exchange resins, said second substance charged with sodium ions and disposed such that in an aqueous environment, said gypsum will react with said second substance to produce sodium sulfate.

72. The device according to claim 67, further comprising:
a fluid connection between a catholyte volume of said electrolyzer and said salt dispensing cartridge (300); and,
flow means for flowing catholyte from said catholyte volume to said salt dispensing cartridge (300).

73. The device according to claim 67, further comprising:
a microprocessor programmed to calculate an amount of mineral introduced into said water at a given flow rate and applied voltage; and,
control means for controlling at least one variable selected from the group consisting of flow rate and applied voltage in order to introduce a predetermined quantity of said mineral into said water.

74. The device according to claim 67, further comprising a user interface comprising selection means that enable a user to select at least one option selected from the group consisting of: a level of mineralization; oxygen enrichment of said water; and hydrogen enrichment of said water.
